(19) United States
(12) Patent Application Publication
(10) Pub. No.: US 2014/0085341 A1
(43) Pub. Date: Mar. 27, 2014

(54) MOBILE DEVICE AND METHOD OF CHANGING SCREEN ORIENTATION OF MOBILE DEVICE

(71) Applicant: Pantech Co., Ltd., Seoul (KR)

(72) Inventors: Hyung Sik SHIN, Seoul (KR); Sang Myoung Kim, Seoul (KR); Kyoung Hun Jeon, Seoul (KR)

(73) Assignee: Pantech Co., Ltd., Seoul (KR)

(21) Appl. No.: 14/029,277

(22) Filed: Sep. 17, 2013

(30) Foreign Application Priority Data
Sep. 24, 2012 (KR) 10-2012-0105575

(51) Int. Cl. G09G 5/38

(52) U.S. Cl. CPC G09G 5/38
USPC 345/659

(57) ABSTRACT

Provided are a mobile device and a method of changing a screen orientation of the mobile device. A method for changing a screen orientation of a mobile device includes: recognizing a motion of the mobile device; determining whether to change the screen orientation of the mobile device based on a first motion sensor of the mobile device; determining whether a viewing direction of a user of the mobile device is matched to the screen orientation of the mobile device based on at least one of the first motion sensor and a second motion sensor; and maintaining the screen orientation of the mobile device in response to a determination that the viewing direction of the user of the mobile device is matched to the screen orientation of the mobile device.

### CROSS-REFERENCE TO RELATED APPLICATIONS

This application claims priority from and the benefit under 35 U.S.C. §119(a) of Korean Patent Application No. 10-2012-0105575, filed on Sep. 24, 2012, which is hereby incorporated by reference in its entirety for all purposes as if fully set forth herein.

### BACKGROUND

1. Field

Exemplary embodiments of the present invention relate to a mobile device and a method of changing a screen orientation of the mobile device.

2. Discussion of the Background

As technologies of mobile devices develop, the number of users utilizing various functions of mobile devices, e.g., web-surfing, viewing moving images, and the like, is increasing. For convenience of such users, certain mobile devices have a function of automatically changing a screen orientation based on a direction of a device.

However, according to the orientation control scheme, a screen orientation of a mobile device is changed based on only the orientation of the mobile device, regardless of a use state of a user, and accordingly a function of changing the screen orientation may cause inconvenience to the user in certain circumstances. Specifically, the screen orientation may be changed according to the expectation of the user when a user is in a correct posture (for example, when the user sits or stands and uses the mobile device such that a line that connects eyes of the user is substantially parallel to the ground). When the user lies and manipulates the mobile device, e.g., when the screen of the mobile device faces downward, the screen orientation may remain unchanged despite the mobile device being rotated by the user, or may be changed even though the user does not rotate the mobile device with an intention for the orientation change. Accordingly, the screen orientation may be unintentionally changed due to slight movement of the mobile device. Additionally, when the user lies on his or her side and looks at the mobile device, the screen orientation may be changed, since the mobile device is rotated, regardless of the user's viewing direction. In this instance, the user's viewing direction is not matched to the screen orientation of the mobile device, which may cause inconvenience of using the mobile device.

### SUMMARY

Exemplary embodiments of the present invention provide a mobile device and a method of changing a screen orientation of the mobile device.

Additional features of the invention will be set forth in the description which follows, and in part will be apparent from the description, or may be learned by practice of the invention.

Exemplary embodiments of the present invention provide a method for changing a screen orientation of a mobile device, the method including: recognizing a motion of the mobile device; determining whether to change the screen orientation of the mobile device based on a first motion sensor of the mobile device; determining whether a viewing direction of a user of the mobile device is matched to the screen orientation of the mobile device based on at least one of the first motion sensor and a second motion sensor; and maintaining the screen orientation of the mobile device in response to a determination that the viewing direction of the user of the mobile device is matched to the screen orientation of the mobile device.

Exemplary embodiments of the present invention provide a method for changing a screen orientation of a mobile device, the method including: recognizing a motion of the mobile device based on a first motion sensor; determining an orientation of a first axis according to a value of the first motion sensor with respect to the first axis, the first axis being perpendicular to a surface of a display screen of the mobile device; in response to a determination that the orientation of the first axis is in a first range, determining whether to change the screen orientation of the mobile device based on the first motion sensor; and, in response to a determination that the orientation of the first axis is in a second range, determining whether to change the screen orientation of the mobile device based on a second motion sensor or based on a user input.

Exemplary embodiments of the present invention provide a mobile device to change a screen orientation of the mobile device, the mobile device including: a first motion sensor to recognize a motion of the mobile device; and a determining unit configured to determine an orientation of a first axis according to a value of the first motion sensor with respect to the first axis, the first axis being perpendicular to a surface of a display screen of the mobile device. In response to a determination that the orientation of the first axis is in a first range, the determining unit determines whether to change the screen orientation of the mobile device based on the first motion sensor; and, in response to a determination that the orientation of the first axis is in a second range, the determining unit determines whether to change the screen orientation of the mobile device based on a second motion sensor or based on a user input.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an example in which a screen orientation of a mobile device is changed according to an exemplary embodiment of the present invention.

FIG. 2A is a flowchart illustrating a method of changing a screen orientation of a mobile device according to an exemplary embodiment of the present invention.

FIG. 2B is a diagram illustrating three axes of a motion sensor according to an exemplary embodiment of the present invention.

FIG. 2C is a diagram illustrating an orientation of a Z-axis of a motion sensor according to an exemplary embodiment of the present invention.

FIG. 3 illustrates graphs of a change in values of an acceleration sensor and a change in values of a gyro sensor based on movement of a user according to an exemplary embodiment of the present invention.

FIG. 4 is a flowchart illustrating operation 230 of FIG. 2A when a Z value of an acceleration sensor is equal to or greater than a first threshold or equal to or less than a second threshold according to an exemplary embodiment of the present invention.

FIG. 5 is a flowchart illustrating operation 230 of FIG. 2A when the Z value of the acceleration sensor is less than the first threshold and greater than the second threshold according to an exemplary embodiment of the present invention.

FIG. 6 is a flowchart illustrating operation 540 of FIG. 5 according to an exemplary embodiment of the present invention.

FIG. 7 is a flowchart illustrating a method of changing a screen orientation of a mobile device according to an exemplary embodiment of the present invention.

FIG. 8 is a flowchart illustrating a method of changing a screen orientation of a mobile device according to an exemplary embodiment of the present invention.

FIG. 9 is a block diagram illustrating a screen orientation change processing unit of a mobile device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

Hereinafter, terms used in the present disclosure will be defined, prior to describing exemplary embodiments of the present invention.

An orientation may determine a mode of the mobile device and may be classified into a forward tilt mode and a backward tilt mode based on an orientation in which a screen of the mobile device is oriented. The forward tilt mode may refer to a state in which the screen of the mobile device tilts forward from a reference line that is perpendicular to the ground. More specifically, the forward tilt mode is a state in which the screen faces downward. In the forward tilt mode, the screen may face downward at a determined angle, when the mobile device is generally used by a user who lies down or leans back. The backward tilt mode may refer to a state in which the screen of the mobile device tilts backward from the reference line. More specifically, the backward tilt mode is a state in which the screen faces upward. In the backward tilt mode, the screen may face upward at a determined angle when the mobile device is generally used by a user who sits or stands.

When the screen of the mobile device has a shape in which a length of a first axis, namely a vertical axis, is different from a length of a second axis, namely a horizontal axis, an orientation of the mobile device may be classified into a vertical orientation and a horizontal orientation. The first axis may be perpendicular to the second axis. The vertical orientation may refer to an orientation in which the mobile device is disposed such that the first axis is perpendicular to or nearly perpendicular to the ground. More specifically, the vertical orientation may refer to an orientation of the mobile device in a state in which a user's viewing direction is matched to the first axis. The horizontal orientation may refer to an orientation that the mobile device is disposed when the second axis is perpendicular to or nearly perpendicular to the ground. The horizontal orientation may refer to an orientation of the mobile device in a state in which a user's viewing direction is matched to the second axis. If a screen of the mobile device has a rectangular shape, the mobile device may have a portrait mode or a landscape mode according to the orientation. The above description with respect to the vertical orientation and the horizontal orientation may also be applied to an example in which the length of the first axis is equal to the length of the second axis.

Further, a change in a screen orientation of the mobile device or a rotation state of the screen of the mobile device may be classified into a vertical mode and a horizontal mode. The vertical mode may refer to an orientation of the screen that is optimized so that the screen is matched to a user's viewing direction when the mobile device is disposed in the vertical orientation. The horizontal mode may refer to an orientation of the screen that is optimized so that the screen is matched to the user's viewing direction when the mobile device is disposed in the horizontal orientation. For example, in a mobile device with an Android operating system (OS), the vertical mode may correspond to a portrait mode, and the horizontal mode may correspond to a landscape mode.

Further, a rate of a change of an acceleration sensor may refer to a rate of a change in an X value and a Y value of an acceleration sensor, and a standard deviation of a gyro sensor may refer to a standard deviation of an X value, a Y value, and a Z value of a gyro sensor.

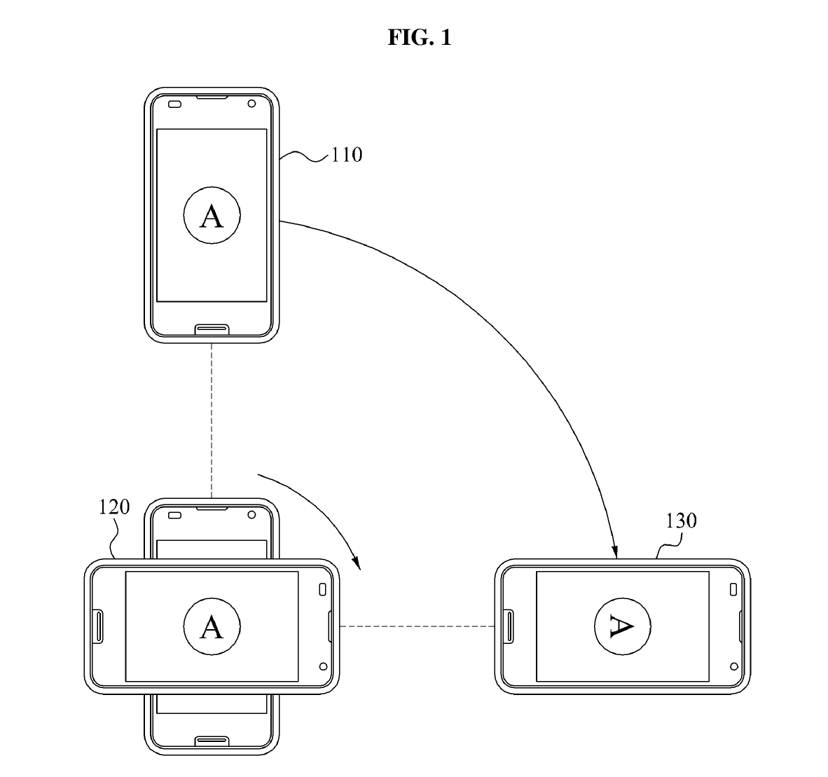

FIG. 1 is a diagram illustrating an example in which a screen orientation of a mobile device is changed according to an exemplary embodiment of the present invention.

Referring to FIG. 1, a screen orientation of a mobile device may be changed based on a state of the mobile device and a rotation of the mobile device. Specifically, in a state 110, when the mobile device is in the backward tilt mode and in the vertical orientation, the screen of the mobile device is in the vertical mode. If the mobile device is rotated to the right or left in the state 110, an orientation of the screen may be changed. Specifically, if the mobile device 110 is rotated by at least an angle close to 90° to the right or left from the vertical orientation while the backward tilt mode is maintained, the screen may be changed from the vertical mode to the horizontal mode in a state 120. In this instance, the orientation of the mobile device in the horizontal mode may be matched to the user's viewing direction depending on whether the mobile device is rotated to the left or right. More specifically, an orientation of the screen of the mobile device in the horizontal mode when the mobile device in the state 110 is rotated to the left may be diametrically opposed to an orientation of the screen of the mobile device in the horizontal mode when the mobile device in the state 110 is rotated to the right. The mobile device may be rotated intentionally by a user to change the screen orientation of the mobile device.

When the mobile device is rotated 90° or 180° to the left or right in the forward tilt mode in the state 120, the screen orientation of the mobile device may be changed. For example, if the mobile device is rotated by at least an angle close to 90° from the vertical orientation to the horizontal orientation while the forward tilt mode is maintained, the screen orientation of the mobile device may be changed from the vertical mode to the horizontal mode in a state 130. If the mobile device in the state 130 is rotated by at least an angle close to 90° from the horizontal orientation to the vertical orientation, the screen orientation of the mobile device may be changed back from the horizontal mode to the vertical mode. In this instance, the mobile device may be rotated intentionally by a user who lies back or on his or her side or sits back to change the screen orientation of the mobile device.

For example, if the backward tilt mode is changed to the forward tilt mode and the mobile device is rotated with a large radius of a rotational motion so as to be oriented from the vertical orientation to the horizontal orientation (or from the horizontal orientation to the vertical orientation), the screen orientation of the mobile device may be maintained to be fixed rather than being changed. In this instance, a user may move while maintaining a viewing direction of the user to be matched to the screen orientation of the mobile device, for example, the user may lie on his or her side by holding the mobile device with his or her hand and the screen orientation may be maintained despite the occurrence of the motion. For example, when a user lies on his or her side in a state in which the screen orientation of the mobile device is used in the vertical mode or horizontal mode, a viewing direction of the user may be the same as the viewing direction prior to lying, however, the mobile device may be rotated by at least an angle that triggers a screen orientation change (from the vertical orientation to the horizontal orientation, or from the horizontal orientation to the vertical orientation). According to exemplary embodiments of the present invention, the above motion of the mobile device may be determined, and accordingly a screen orientation optimized for a user's viewing direction and a state in which a user uses the mobile device may be provided.

One or more motion sensors may be embedded in a mobile device to determine a change of a screen orientation of a mobile device. The one or more device motion sensors may include various types of sensors that sense a rotation, an acceleration, a velocity/speed, an angular displacement, an angular velocity/speed, and/or an orientation change of the mobile device. For example, one or more device motion sensors may include an acceleration sensor (e.g., accelerometer), a gyro sensor (e.g., gyroscope), a Global Positioning System (GPS), a magnetometer, a gravity sensor, and the like. Further, a device motion sensor that recognizes a motion of a mobile device is different from an exterior object motion sensor, which is a sensor to recognize a motion of an exterior object, such as an image sensor/camera to capture a viewing direction of a user of a mobile device, or to recognize positions of eyes of the user to determine the viewing direction.

According to aspects, if a line that connects two eyes of the user of the mobile device is substantially perpendicular to a line that connects the center of the upper side of a screen image and the center of the bottom side of the screen image, the viewing direction of the user is matched to the screen orientation of the displayed screen image in the mobile device. If the line that connects two eyes of the user of the mobile device is substantially perpendicular to a line that connects the center of the left side of the screen image and the center of the right side of the screen image, the viewing direction of the user is not matched to the screen orientation of the displayed screen image in the mobile device. However, aspects of the present invention are not limited thereto.

Hereinafter, a method of changing a screen orientation of a mobile device according to exemplary embodiments of the present invention will be described in detail.

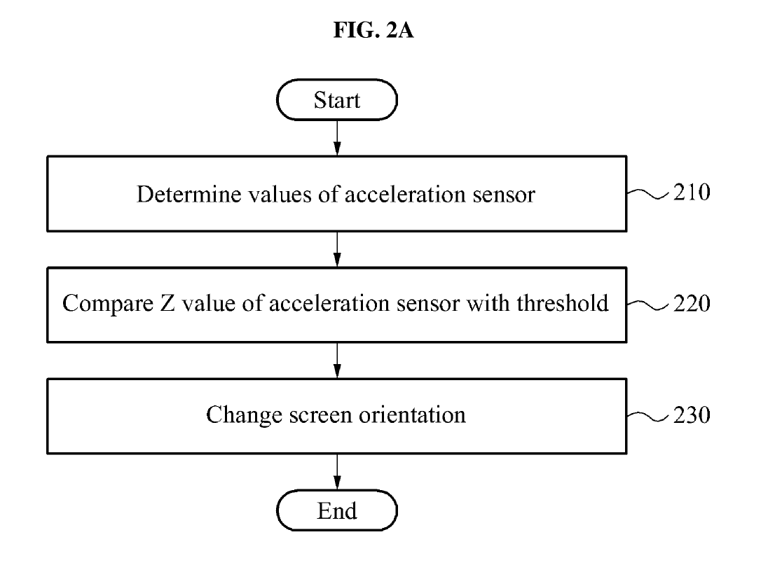

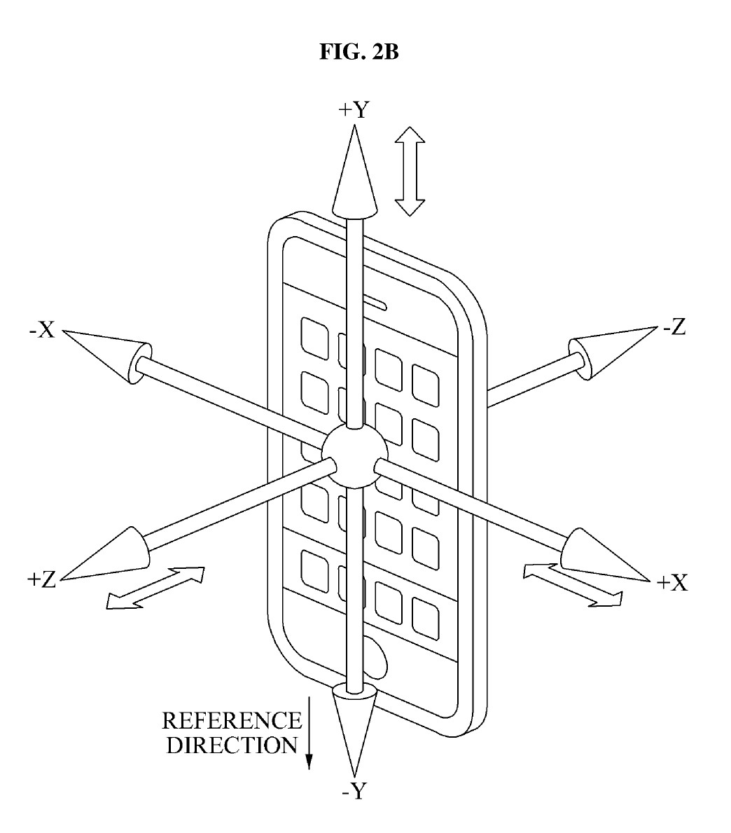

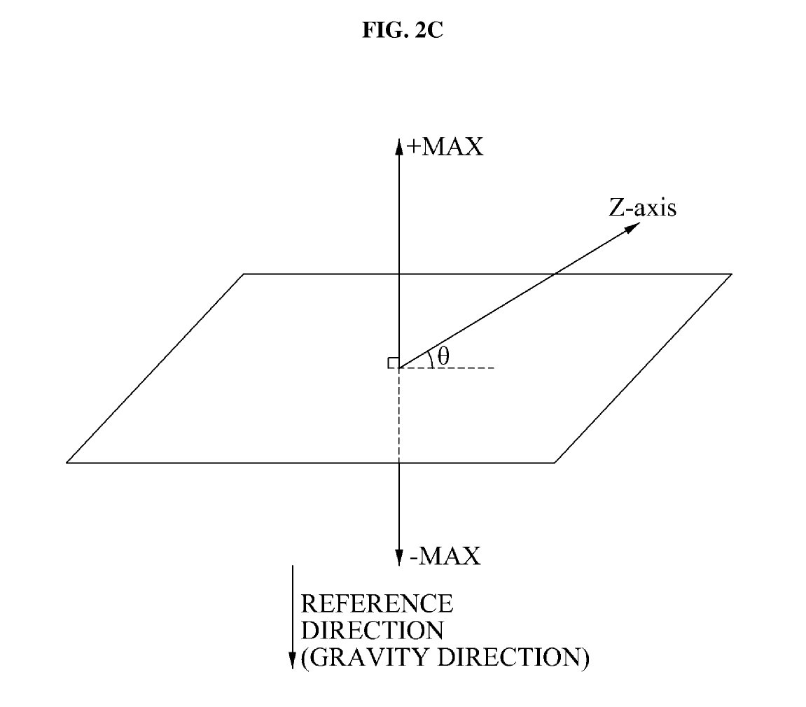

FIG. 2A is a flowchart illustrating a method of changing a screen orientation of a is mobile device according to an exemplary embodiment of the present invention. FIG. 2B is a diagram illustrating three axes of a motion sensor according to an exemplary embodiment of the present invention. FIG. 2C is a diagram illustrating an orientation of a Z-axis of a motion sensor according to an exemplary embodiment of the present invention.

Referring to FIG. 2A, in operation 210, values of an acceleration sensor of the mobile device may be verified.

The acceleration sensor may be a sensor used to measure inertial reaction and to detect a linear acceleration. The acceleration sensor may measure acceleration values in three directions, e.g., an X-axis direction, a Y-axis direction, and a Z-axis direction according to Cartesian coordinate system, but is not limited thereto. The X-axis direction may refer to a horizontal direction of the mobile device, and the Y-axis direction may refer to a vertical direction of the mobile device. Further, the Z-axis direction may refer to a forward-backward direction of the mobile device. As shown in FIG. 2B, the X-axis may be parallel to two shorter edges of a screen of the mobile device, and the Y-axis may be parallel to two longer edges of the screen of the mobile device. The Z-axis may be perpendicular to the screen of the mobile device. Further, as shown in FIG. 2C, the acceleration sensor may calculate acceleration of the mobile device with respect to the X, Y, and Z axes, and each of X-axis value, Y-axis value, and Z-axis value may be determined by an angle ‘θ’ between the corresponding axis and a reference direction or between the corresponding axis and a plane perpendicular to the reference direction (the reference direction may be the direction of gravity, for example). For example, as shown in FIG. 2C, if the angle between the Z-axis and the plane perpendicular to the direction of gravity is 90 degrees, the Z-axis value may be at a positive maximum value, MAX. If the angle between the Z-axis and the plane perpendicular to the direction of gravity is −90 degrees, the Z-axis value is may be at a negative maximum value, −MAX (the negative maximum value is the minimum value in the available range, but the absolute value of the negative maximum value is the maximum value in the available range). If the angle between the Z-axis and the plane perpendicular to the direction of gravity is 0 degree, the Z-axis value may be zero. For example, as shown in FIG. 2B, if the Y-axis is parallel to the direction of gravity and the X and Z axes are parallel to the plane perpendicular to the direction of gravity, the Y-axis may have a positive maximum value within a range of (−MAX, MAX). The X and Z axes values may have zero values.

In the method of FIG. 2A, a relative rotation state of the mobile device with respect to a user's viewing direction may be determined. In this instance, the relative rotation state may refer to a rotation state of the mobile device based on a state of a user, to determine whether the screen orientation of the mobile device is to be changed, rather than referring to only the rotation state of the mobile device. The state of the user may include a user's pose and/or a user's viewing direction.

When the mobile device is in a backward tilt mode, more specifically, when the mobile device with a screen facing upward (the Z-axis value is positive) is rotated, a user may more comfortably use the mobile device due to a change in the screen orientation. However, when the mobile device is in a forward tilt mode, more specifically, when the mobile device with the screen facing downward (the Z-axis value is negative) is rotated, the user may feel inconvenience due to the change in the screen orientation.

Further, a slope or the z-axis value of the mobile device may be determined based on a pose of a user. More specifically, the relative rotation state of the mobile device may be determined based on the user's viewing direction. Accordingly, in the method of FIG. 2A, another algorithm may be executed based on the relative rotation state of the mobile device with respect to the user's viewing direction.

The relative rotation state of the mobile device with respect to the user's viewing direction may be determined based on an angle at which a mobile device tilts toward a Z-axis. For example, a pose of a user may be predicted based on whether the mobile device is in the forward tilt mode or the backward tilt mode, and the forward tilt mode and the backward tilt mode may be determined based on a value of a Z-axis of the acceleration sensor, hereinafter referred to as the Z-axis value or a ‘Z value.’ Hereinafter, description will be given of an example in which the Z value is ‘0’ when the mobile device is perpendicular to the ground, in which the Z value is a positive integer greater than ‘0’ when the mobile device is in the backward tilt mode, and in which the Z value is a negative integer less than ‘0’ when the mobile device is in the forward tilt mode.

Further, a value of an X-axis of the acceleration sensor, hereinafter referred to as an ‘X value,’ and a value of a Y-axis of the acceleration sensor, hereinafter referred to as a ‘Y value,’ may be monitored continuously or periodically. The Z value may be verified when an amount of a change in the X value and the Y value of the acceleration sensor is equal to or greater than a critical range that is set in advance.

Specifically, when a user rotates a mobile device, the X value and Y value of the acceleration sensor may be changed based on a rotation angle of the mobile device. Since the Z value of the acceleration sensor indicates a degree that the mobile device tilts forward and backward, the Z value may not be continuously monitored when the X value and Y value of the acceleration sensor are changed within the critical range. Changes in the X value and the Y value in a level equal to or lower than a threshold level that triggers a change of a screen orientation of the mobile device may correspond to the motion of the mobile device in a normal use, (for example, a user moves the mobile device or adjusts his or her grip on the mobile device, and the like), and thus a change in the Z value may not need to be continuously monitored. Accordingly, in the method of FIG. 2A, when the X value and the Y value of the acceleration sensor are changed beyond the critical range, the Z value of the acceleration sensor may be verified.

However, similar to the X value and the Y value, the Z value may be verified or monitored continuously or periodically.

In operation 220, the Z value of the acceleration sensor may be compared with a threshold. Specifically, a motion of the mobile device may be detected using different schemes based on the relative rotation state of the mobile device, and different algorithms may be performed based on the Z value of the acceleration sensor.

When the Z value of the acceleration sensor is equal to or greater than the threshold, the mobile device may typically be in the backward tilt mode in which a user generally uses the mobile device without lying on his or her side, for example, when the user sits or stands. Accordingly, it may be possible to change a screen orientation to a direction that corresponds to the user's viewing direction or that the user desires to change, even though the X value and the Y value of the acceleration sensor have been changed to trigger a change of the screen orientation.

When the Z value of the acceleration sensor is less than the threshold, the mobile device may be in the forward tilt mode in which a user may use the mobile device while lying on his or her side by holding the mobile device with a hand, or while lying back and holding the mobile device such that the screen of the mobile devices faces the ground. If the mobile device is in the forward tilt mode, to more accurately determine whether the screen orientation of the mobile device is to be changed, additional determination process may be performed. Accordingly, when the Z value of the acceleration sensor is less than the threshold, the screen orientation of the mobile device may be changed using an algorithm that is different from an algorithm used when the Z value is equal to or greater than the threshold or is not activated when the Z value is equal to or greater that the threshold.

The threshold may refer to a value set as a reference value of the Z value of the acceleration sensor to determine whether the mobile device is in the forward tilt mode or the backward tilt mode and to determine different algorithms for changing the screen orientation of the mobile device. For example, in the method of FIG. 2A, the threshold may be set to a range, e.g., Z value range corresponding to 0 degree to 10 degrees or a set value, e.g., ‘0.’

If the threshold is set to ‘0,’ when a user lies on his or her side by holding a mobile device with his or her hand, the screen of the mobile device may be substantially perpendicular to the ground, but may slightly tilt backward, and a change of a screen orientation of the mobile device may be determined based on the X value and the Y value of the acceleration sensor. Accordingly, a user's viewing direction may not be matched to the screen orientation of the mobile device. More specifically, when the user lies on his or her side and uses the mobile device in the backward tilt mode in which the mobile device is nearly perpendicular to the ground (for example, when the user uses the mobile device that slightly tilts backward with respect to the ground or that is perpendicular to the ground), a change of the screen orientation of the mobile device may be determined based on the X value and the Y value of the acceleration sensor according to the determination algorithm in the backward tilt mode. In this instance, since the X value and the Y value of the acceleration sensor are changed to trigger a change of the screen orientation, the screen orientation of the mobile device may be changed in a direction perpendicular to the user's viewing direction, which does not match to the screen orientation. For example, when the user's viewing direction is a vertical direction when the user lies on his or her side, the screen orientation of the mobile device may be changed to the horizontal mode.

To more accurately change the screen orientation, the threshold may be set to a value between ‘0’ and ‘2,’ and may be set to a value between ‘0’ and ‘1’ when the maximum value is ‘10,’ which corresponds to 90 degrees. Accordingly, the screen orientation of the mobile device may be changed to meet a user's intention and to reflect user's pose in using the mobile device, based on additional determinations when more accurate determination is required, if it is not determined that a user intentionally rotates the mobile device for changing the screen orientation. The additional determination may be performed based on an X value, a Y value, and a Z value of a gyro sensor.

The threshold may be set to different values. For example, a first threshold and a second threshold may be independently set. More specifically, a change of the screen orientation of the mobile device may be determined using different methods based on whether the Z value of the acceleration sensor is within or beyond a threshold range. The threshold range may refer to a range between the first threshold and the second threshold.

In operation 230, the screen orientation of the mobile device may be changed, based on a result of comparing the Z value with the threshold. In the method of FIG. 2A, a change of the screen orientation may be determined using different methods based on the result of comparing the Z value with the threshold.

If the Z value of the acceleration sensor is equal to or greater than the threshold, the change of the screen orientation may be determined based on the X value and the Y value of the acceleration sensor. If the Z value of the acceleration sensor is less than the threshold, the change of the screen orientation may be determined based on values of the acceleration sensor and values of the gyro sensor.

The gyro sensor may be a sensor used to measure of an angular velocity of an object with respect to a reference axis. The gyro sensor may calculate an angular displacement of a moving or rotating object with respect to a reference axis in a unit time and convert the calculated value into a numerical value. The gyro sensor may detect an angular velocity affecting an inertial system from the Coriolis force generated when a mobile device moves. The gyro sensor, e.g., a gyroscope, may be included in the mobile device. An X value, a Y value and a Z value of the gyro sensor may refer to an angle at which the moving object is rotated with respect to X axis, Y axis, and Z axis of the gyro sensor, respectively. Further, the X, Y, and Z values of the gyro sensor may be angular displacements or angular velocities (radian or radian/second) with respect to the corresponding axis. Specifically, the X value of the gyro sensor may be obtained by converting an angle at which a moving object is rotated with respect to the X axis of the gyro sensor in a unit time. The Y value of the gyro sensor may be obtained by converting an angle at which a moving object is rotated with respect to the Y axis of the gyro sensor in a unit time, and the Z value of the gyro sensor may be obtained by converting an angle at which a moving object is rotated with respect to the Z axis of the gyro sensor in a unit time.

If the Z value of the acceleration sensor is compared with the first threshold and the second threshold that are set in operation 220, the change of the screen orientation may be determined using different schemes based on the range determined by the first threshold and the second threshold. Specifically, when the Z value of the acceleration sensor is located beyond the range (when the Z value of the acceleration sensor is greater than the first threshold, or is less than the second threshold, which is smaller than the first threshold), the screen orientation may be changed based on the change in the acceleration sensor, e.g., the amount of the change in the X value and the Y value of the acceleration sensor. When the Z value of the acceleration sensor is located within the range (when the Z value of the acceleration sensor is a value between the first threshold and the second threshold, the screen orientation may be changed based on the changes of the values of the acceleration sensor, e.g., the amount of the change in the X value and the Y value of the acceleration sensor, and based on changes of values of the gyro sensor. For example, the first threshold may be set to a value between ‘+1’ and ‘+3,’ and the second threshold may be set to a value between ‘−1’ and ‘−3’ when the positive maximum value is 10 and the negative maximum value is −10

When changes of the X value and the Y value of the acceleration sensor are equal to or greater than the set range, which may be set in advance or set by a user, a change of the screen orientation may be determined by a user. Specifically, if the Z value of the acceleration sensor is less than the threshold in operation 220 and changes of the X value and the Y value of the acceleration sensor are equal to or greater than a threshold for triggering a screen orientation change, or if the Z value of the acceleration sensor is a value between the first threshold and the second threshold and the changes of the X value and the Y value of the acceleration sensor are equal to or greater than the threshold for triggering a screen orientation change, a user interface (UI), such as a pop-up window, may be displayed on the screen of the mobile device. The UI may enable a user to select whether to change the screen orientation. Accordingly, the user may select whether to change the screen orientation, and the screen orientation may be changed based on the selection of the user. If the user does not select whether to change the screen orientation, the screen orientation may remain unchanged or may be changed according to the changes of X value and the Y value of the acceleration sensor.

If a user performs a specific gesture, the screen orientation may be fixed. Specifically, when the amount of the change in the X value and the Y value of the acceleration sensor is equal to or greater than the threshold, and if the user performs a specific gesture, the screen orientation may remain unchanged. In this instance, the specific gesture may include a gesture performed by the user to press a specific button, a gesture performed by the user to press a screen of a mobile device with his or her finger, a gesture performed by the user to select or touch a UI (for example, a screen orientation change button, and the like) displayed on the screen of the mobile device, and the like. For example, the user holding the mobile device with his or her hand may lie on his or her side, and may perform a gesture to prevent the screen orientation from being changed.

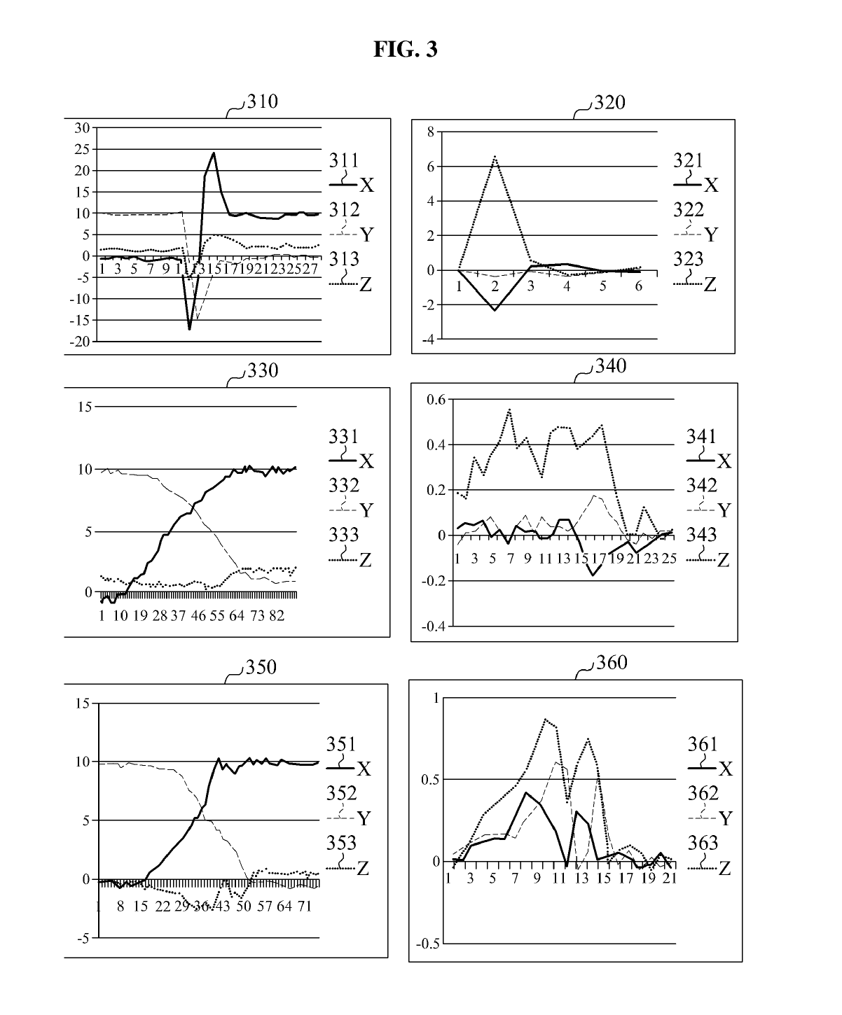

FIG. 3 illustrates graphs of a change in values of an acceleration sensor and a change in values of a gyro sensor based on movement of a user according to an exemplary embodiment of the present invention.

In general, when a user intentionally rotates a mobile device to change a screen orientation of the mobile device, the mobile device may be relatively rapidly rotated. When the user rotates the mobile device without a purpose of changing the screen orientation, the mobile device may be relatively slowly rotated.

In FIG. 3, graphs 310 and 320 represent a change in values of an acceleration sensor and a change in values of a gyro sensor, respectively, in an example in which the mobile device is rotated 90° with a small rotation radius at a high speed. In the graphs 310 and 320, solid lines 311 and 321 represent an X value of the acceleration sensor and an X value of the gyro sensor, respectively, dotted lines 312 and 322 represent a Y value of the acceleration sensor and a Y value of the gyro sensor, respectively, and dotted lines 313 and 323 represent a Z value of the acceleration sensor and a Z value of the gyro sensor, respectively. Further, graphs 330 and 340 represent a change in values of the acceleration sensor and a change in values of the gyro sensor, respectively, in an example in which the mobile device is rotated 90° with a small rotation radius at a low speed. In the graphs 330 and 340, solid lines 331 and 341 represent an X value of the acceleration sensor and an X value of the gyro sensor, respectively, dotted lines 332 and 342 represent a Y value of the acceleration sensor and a Y value of the gyro sensor, respectively, and dotted lines 333 and 343 represent a Z value of the acceleration sensor and a Z value of the gyro sensor, respectively. Further, graphs 350 and 360 represent a change in values of the acceleration sensor and a change in values of the gyro sensor, respectively, in an example in which the mobile device is rotated with a large rotation radius at a low speed. In the graphs 350 and 360, solid lines 351 and 361 represent an X value of the acceleration sensor and an X value of the gyro sensor, respectively, dotted lines 352 and 362 represent a Y value of the acceleration sensor and a Y value of the gyro sensor, respectively, and dotted lines 353 and 363 represent a Z value of the acceleration sensor and a Z value of the gyro sensor, respectively. In each of the graphs 310 to 360, a horizontal axis represents a sampling time, and a vertical axis represents a numerical value of each data.

As shown in FIG. 3, a slope of the graph 310 is greater than a slope of each of the graphs 330 and 350. A rate of a change of the acceleration sensor of the graph 310 is greater than a rate of a change of the acceleration sensor of each of the graphs 330 and 350.

In general, a high rate of a change of an acceleration sensor may indicate that a user rotates a mobile device to change a screen orientation of the mobile device. Accordingly, when a mobile device is rotated 90° with a small rotation radius at a high speed, a screen orientation of the mobile device may be changed based on a change of values in an acceleration sensor.

In the graphs 330 and 350, rates of changes of the acceleration sensors are similar to each other despite different movements. If detected values of the acceleration sensor show data similar to the data in the graphs 330 and 350, the screen orientation may be changed based on the values of the acceleration sensor and a standard deviation of values of a gyro sensor.

As shown in FIG. 3, a standard deviation of values of the gyro sensor in the graph 360 is greater than a standard deviation of values of the gyro sensor of the graph 340, which may indicate a greater change of values in a gyro sensor when a mobile device is rotated by a user with a large rotation radius compared to the change of values in the gyro sensor when a mobile device is rotated by a user with a small rotation radius. In an example of a low rate of a change of values in an acceleration sensor and a greater change of values in a gyro sensor as shown in the graphs 350 and 360, it may be determined that a user moves together with a mobile device while the user's viewing direction is matched to a screen orientation of the mobile device. In this instance, matching between the user's viewing direction and the screen orientation may indicate that the user's viewing direction continues to match the screen of the mobile device (for example, the motion of the mobile device corresponds to the motion of the user when the user lies on his or her side while using the mobile device).

In this instance, since the user's viewing direction is matched to the screen orientation of the mobile device, the screen orientation may be unchanged according to the detected values of the acceleration sensor and the gyro sensor.

In an example of a low rate of a change of an acceleration sensor and a low change in a gyro sensor as shown in graphs 330 and 340, a user may move a mobile device to change a screen orientation of the mobile device. In this instance, the screen orientation of the mobile device may be changed based on a change in an X value and a Y value of the acceleration sensor.

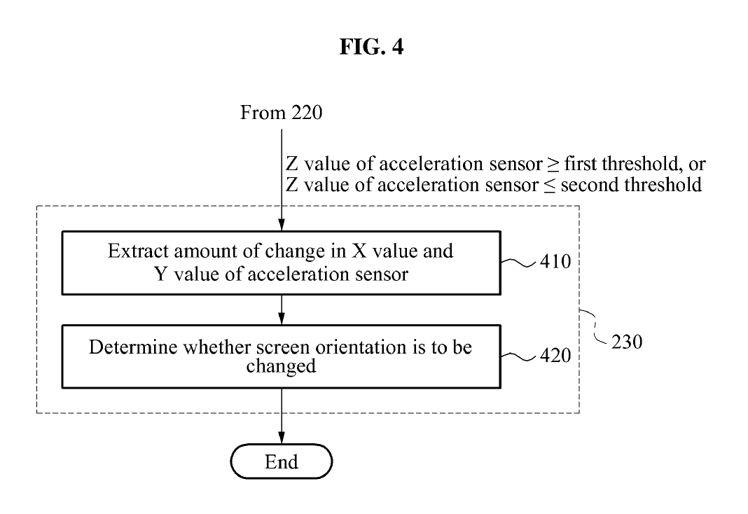

FIG. 4 is a flowchart illustrating operation 230 of FIG. 2A when the Z value of the acceleration sensor is equal to or greater than the first threshold (“upper threshold”) or equal to or less than the second threshold (“lower threshold”) according to an exemplary embodiment of the present invention.

Referring to FIG. 4, in operation 410, an amount of a change in the X value and the Y value of the acceleration sensor may be extracted. The amount of the change in the X value and the Y value may correspond to a rotation amount of the mobile device with respect to the corresponding axis. The X value of the acceleration sensor may indicate horizontal movement of the mobile device based on a horizontal direction of the mobile device, and the Y value of the acceleration sensor may indicate vertical movement of the mobile device based on a vertical direction of the mobile device. More specifically, the X value of the acceleration sensor may be obtained by converting, into a numerical value, a linear acceleration of a moving object in a unit time based on the X-axis of the acceleration sensor, and the Y value of the acceleration sensor may be obtained by converting, into a numerical value, a linear acceleration of a moving object in a unit time based on the Y-axis of the acceleration sensor.

In operation 230 (operation 410), data sampling may be used to extract the amount of the change in the X value and the Y value of the acceleration sensor. The data sampling may indicate extracting a certain amount of data that is similar to a population from a large amount of data. Accordingly, by using data sampling, required data may be more efficiently extracted in the operation 230 (the operation 410).

In operation 420, whether the screen orientation of the mobile device is to be changed may be determined based on the extracted amount of the change. In operation 230 (operation 420), a reference value corresponding to the X value and the Y value of the acceleration sensor may be set. In an example, when a mobile device is oriented in a forward vertical orientation (when a single receiver is located in the upper side of a screen of the mobile device), the X value and the Y value of the acceleration sensor may be set to ‘0’ and ‘y1,’ respectively. In another example, when a mobile device is oriented in a horizontal orientation that is rotated 90° to the left from the forward vertical orientation (when a single receiver is located in the left side of the screen of the mobile device), the X value and the Y value of the acceleration sensor may be set to ‘x1’ and ‘0,’ respectively. In still another example, when a mobile device is oriented in a horizontal orientation that is rotated 90° to the right from the forward vertical orientation (when a single receiver is located in the right side of the screen of the mobile device), the X value and the Y value of the acceleration sensor may be set to ‘−x1’ and ‘0,’ respectively. In yet another example, when a mobile device is oriented in a reversed vertical orientation (when a single receiver is located in the side of the screen of the mobile device), the X value and the Y value of the acceleration sensor may be set to ‘0’ and ‘−y1,’ respectively. In this instance, x1 and y1 may be ‘9.8.’

Accordingly, when the X value of the acceleration sensor is changed from ‘0’ to ‘x1’ or ‘−x1’, and when the Y value of the acceleration sensor is changed from ‘y1’ or ‘−y1’ to ‘0,’ the screen of the mobile device may be changed from the vertical mode to the horizontal mode. Further, when the X value of the acceleration sensor is changed from ‘x1’ or ‘−x1’ to ‘0’, and when the Y value of the acceleration sensor is changed from ‘0’ to ‘y1’ or ‘−y1,’ the screen of the mobile device may be changed from the horizontal mode to the vertical mode. Additionally, based on whether the X value of the acceleration sensor is ‘x1’ or ‘−x1,’ the screen of the mobile device may be changed to the horizontal mode suitable for an orientation of the mobile device. In addition, based on whether the Y value of the acceleration sensor is ‘y1’ or ‘−y1,’ the screen of the mobile device may be changed to the vertical mode suitable for an orientation of the mobile device (forward vertical mode or reversed vertical mode). Specifically, when the X value and the Y value of the acceleration sensor are set to ‘x1’ and ‘0,’ based on the vertical mode of the screen in which the X value and the Y value of the acceleration sensor are set to ‘0’ and ‘1’ when the mobile device is oriented in the forward vertical orientation (that is, when the single receiver is located in the upper side of the screen), the screen may be changed to a horizontal mode in which the screen is rotated 90° to the left. When the X value and the Y value of the acceleration sensor are set to ‘−x1’ and ‘0,’ the screen may be changed to a horizontal mode in which the screen is rotated 90° to the right. Furthermore, when the X value and the Y value of the acceleration sensor are set to ‘0’ and ‘−y1,’ the screen may be changed to a vertical mode in which the screen is rotated 180°. Accordingly, the screen orientation of the mobile device may be changed to an orientation optimized to a user's viewing direction, regardless of the orientation of the mobile device manipulated by a user.

The screen orientation of the mobile device may be changed if the X value of the acceleration sensor is substantially similar to the values of ‘0’ or ‘x1/−x1’ and the Y value of the acceleration sensor is substantially similar to the values of ‘y1/−y1’ or ‘0,’ or may be changed when the X value and the Y value of the acceleration sensor exceed a reference value. In this instance, the reference value of the X value of the acceleration sensor may be set to at least one value from a range of ‘0’ to ‘x1’ and a range of ‘−x1’ to ‘0,’ and the reference value of the Y value of the acceleration sensor may be set to at least one value from a range of ‘0’ to ‘y1’ and a range of ‘−y1’ to ‘0.’

Further, in the method of FIG. 2A, the Z value of the acceleration sensor may be continuously monitored, and it may be determined whether the Z value of the acceleration sensor is maintained to be equal to or greater than the threshold.

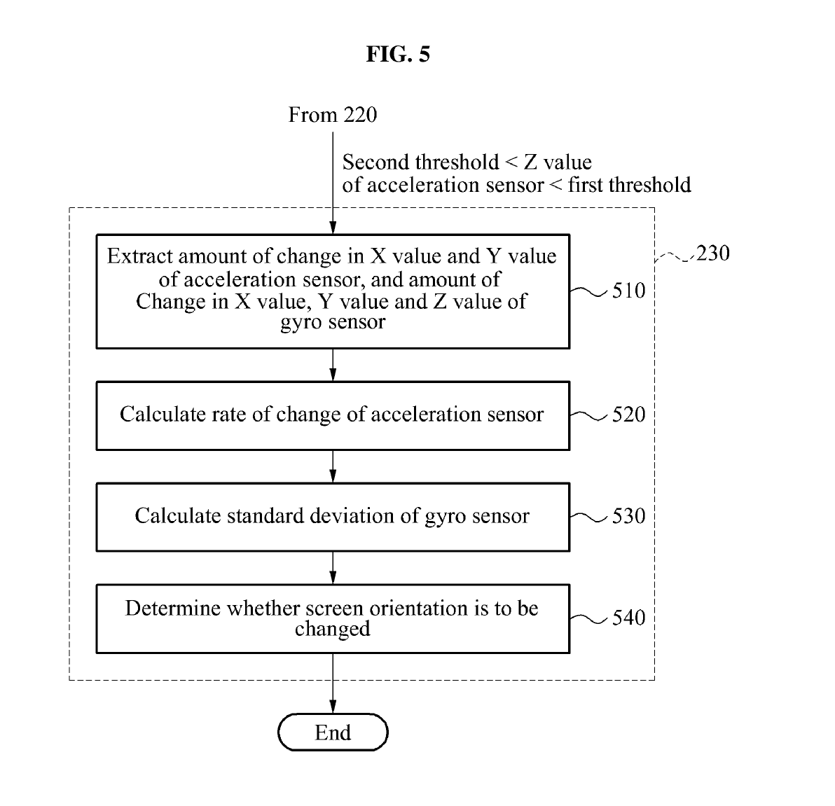

FIG. 5 is a flowchart illustrating operation 230 of FIG. 2A when the Z value of the acceleration sensor is less than the first threshold and greater than the second threshold according to an exemplary embodiment of the present invention.

Referring to FIG. 5, in operation 510, an amount of a change in the X value and the Y value of the acceleration sensor, and an amount of a change in the X value, the Y value, and the Z value of the gyro sensor may be extracted. The amount of the change in the X value and the Y value of the acceleration sensor may correspond to a rotation amount of the mobile device. The X value and the Y value of the acceleration sensor may be obtained by converting, into numerical value, linear accelerations of a moving object in a unit time based on the X-axis and the Y-axis of the acceleration sensor, respectively.

Based on the amount of the change in the X value and the Y value of the acceleration sensor, it may be determined whether the mobile device continues to move and whether the motion speed of the mobile device is rapid.

Further, the X value, the Y value and the Z value of the gyro sensor may be obtained by converting, into numerical value, an angle at which a moving object is moved in a unit time based on the X-axis, the Y-axis and the Z axis of the gyro sensor, respectively.

Maintaining the X value, the Y value, and the Z value of the gyro sensor to be ‘0’ for a predetermined period of time may indicate a stable state in which a user holds a mobile device with his or her hand or the mobile device is not moving. A change in the X value, the Y value, and/or the Z value of the gyro sensor greater than a reference value may indicate a large rotation radius of the mobile device.

In operation 230 (operation 510), data sampling may be used to extract the amount of the change in the X value and the Y value of the acceleration sensor, and the amount of the change in the X value, the Y value, and the Z value of the gyro sensor.

The data sampling may be used to more efficiently extract useful data. For example, a data sampling time may be set to 60 milliseconds (ms), the amount of the change in the X value and the Y value of the acceleration sensor, and the amount of the change in the X value, the Y value, and the Z value of the gyro sensor may be extracted based on the set sampling rate.

In operation 230 (operation 510), a moving average algorithm may be used to reduce a deviation between a maximum value and a minimum value of each of the amount of the change in the X value and the Y value of the acceleration sensor, and the amount of the change in the X value, the Y value, and the Z value of the gyro sensor. The moving average algorithm may be a scheme of reducing a deviation between a maximum value and a minimum value of data and increasing accuracy of data, instead of representing, as a result value, an outlier that is inconsistent with an overall data trend. Accordingly, the moving average algorithm may be applied to the amount of the change in the X value and the Y value of the acceleration sensor, and the amount of the change in the X value, the Y value, and the Z value of the gyro sensor, and thus more accurate data may be extracted.

In operation 520, a rate of a change in the X value and the Y value of the acceleration sensor may be calculated. The rate of the change in the X value and the Y value of the acceleration sensor may be calculated using the following Equation 1:

$$\frac{MAX - MIN}{{△}_{=} T} \qquad [ Equation 1 ]$$

In Equation 1, MAX denotes a maximum value of each of the X value and the Y value of the acceleration sensor, and MIN denotes a minimum value of each of the X value and the Y value of the acceleration sensor. Additionally, T denotes a data sampling time of the X value and the Y value of the acceleration sensor. As the rate of the change of the acceleration sensor increases, it may indicate that a user moves the mobile device rapidly.

In operation 530, a standard deviation of the X value, the Y value, and the Z value of the gyro sensor may be calculated.

The standard deviation may indicate a degree of distribution of the X value, the Y value, and the Z value of the gyro sensor. The standard deviation of the X value, the Y value, and the Z value of the gyro sensor may be calculated using the following Equation 2:

$$S = \sqrt{\frac{1}{N} {\sum }_{i = 1}^{N} {( {x}_{i} - \overline{x} )}^{2}} \qquad [ Equation 2 ]$$

In Equation 2, N denotes a number of sampling data, xᵢ denotes each data, and x̅ denotes an average of the data.

When the rate of the change of the acceleration sensor is less than a threshold that is set in advance, it may be determined whether the screen orientation is to be changed may be determined, based on the calculated standard deviation.

In operation 540, it may be determined whether the screen orientation is to be changed based on the calculated rate of the change of the acceleration sensor and the calculated standard deviation of the gyro sensor.

To accurately determine whether the screen orientation is to be changed in operation 230 (operation 540), a third threshold associated with the rate of the change of the acceleration sensor, and a fourth threshold associated with the standard deviation of the gyro sensor may be set. In this instance, when the rate of the change of the acceleration sensor is equal to or greater than the third threshold, it may be determined whether the screen orientation is to be changed using the amount of the change in the X value and/or the Y value of the acceleration sensor without considering values of the gyro sensor. When the rate of the change of the acceleration sensor is less than the third threshold, it may be determined whether the screen orientation is to be changed based on the standard deviation of the X value, the Y value, and the Z value of the gyro sensor and the amount of the change in the X value and/or the Y value of the acceleration sensor.

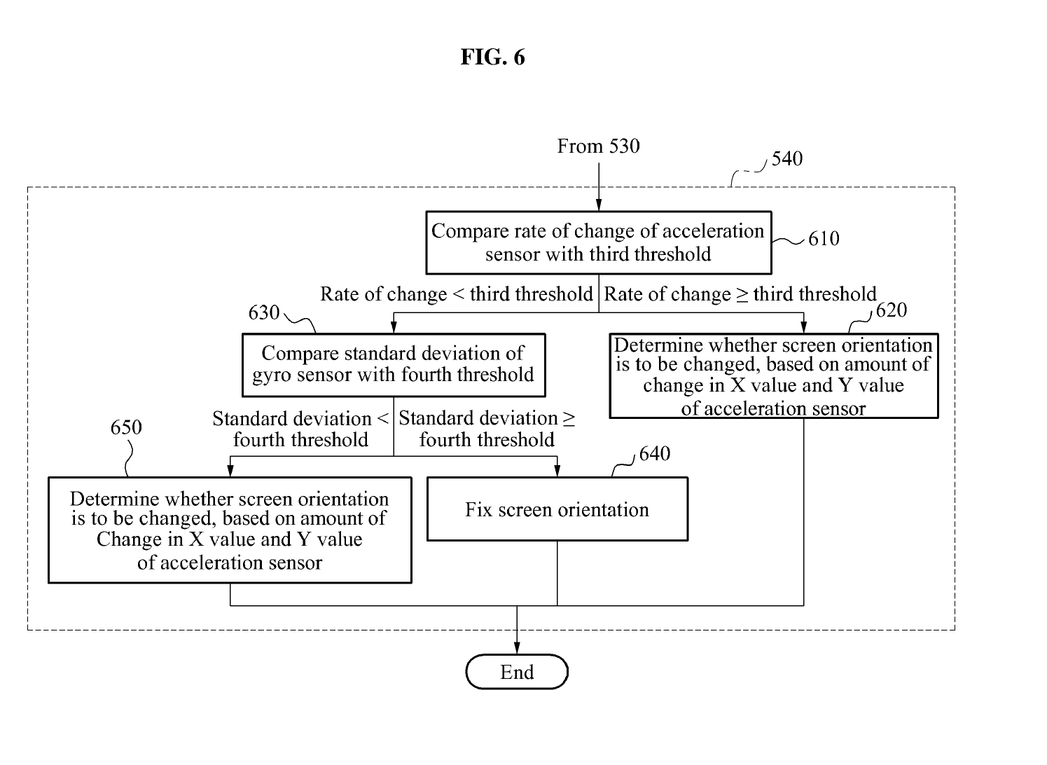

FIG. 6 is a flowchart illustrating operation 540 of FIG. 5 according to an exemplary embodiment of the present invention.

Referring to FIG. 6, in operation 610, the rate of the change of the acceleration sensor may be compared with the third threshold. In this instance, the third threshold may be set as a reference value of the rate of the change of the acceleration sensor, to more accurately change the screen orientation of the mobile device.

When the rate of the change of the acceleration sensor is equal to or greater than the third threshold, it may be determined whether the screen orientation is to be changed may be determined based on the amount of the change in the X value and the Y value of the acceleration sensor in operation 620. When the mobile device is rotated at a relatively high speed, a high rate of the change of the acceleration sensor may be measured. In order to change the screen orientation, a user may rapidly rotate the mobile device. Accordingly, when the rate of the change of the acceleration sensor is equal to or greater than the third threshold, it may be determined that the mobile device has been rotated by the user to change the screen orientation.

For example, when the screen is oriented in the vertical orientation, the X value and the Y value of the acceleration sensor may be set to ‘0’ and ‘y1/−y1,’ respectively. When the screen is oriented in the horizontal orientation, the X value and the Y value of the acceleration sensor may be set to ‘x1/−x1’ and ‘0,’ respectively. When the X value is changed from ‘0’ to ‘x1/−x1’ and the Y value is changed from ‘y1/−y1’ to ‘0,’ the screen orientation of the mobile device may be changed from the vertical orientation to the horizontal orientation. Determining of whether the screen orientation is to be changed based on a change in the X value and the Y value of the acceleration sensor may be similar to operation 420 of FIG. 4, and thus further description thereof is omitted.

When the rate of the change of the acceleration sensor is less than the third threshold, the standard deviation of the gyro sensor may be compared with the fourth threshold in operation 630. In this instance, the fourth threshold may be set in advance as a reference value for the comparison with the standard deviation of the gyro sensor.

When the rate of the change of the acceleration sensor is less than the third threshold and the standard deviation of the gyro sensor is equal to or greater than the fourth threshold, the screen orientation of the mobile device may be fixed in operation 640. In this instance, the standard deviation of the gyro sensor that is equal to or greater than the fourth threshold may indicate a large rotation radius of motion of the mobile device, and accordingly the mobile device may be rotated with large motion. For example, when a user lies on his or her side by holding a mobile device, the mobile device may move along a parabola trace. In this instance, since the relative orientation of a screen that the user views remains unchanged, the user may not desire to change the screen of the mobile device. Accordingly, when the rate of the change of the acceleration sensor is less than the third threshold and the standard deviation of the gyro sensor is equal to or greater than the fourth threshold, the screen orientation may be fixed without being changed.

Further, when the rate of the change of the acceleration sensor is less than the third threshold and the standard deviation of the gyro sensor is less than the fourth threshold, it may be determined whether the screen orientation is to be changed based on the amount of the change in the X value and the Y value of the acceleration sensor in operation 650. In this instance, the rate of the change of the acceleration sensor that is less than the third threshold may indicate that a user rotates the mobile device at a relatively low speed. Further, the standard deviation of the gyro sensor that is less than the fourth threshold indicates a small rotation radius of motion of the mobile device, and accordingly the mobile device may be rotated with small motion. For example, the user may rotate the mobile device at a low speed to change the screen orientation, and accordingly the screen orientation may be changed based on the amount of the change in the X value and the Y value of the acceleration sensor in operation 230 (operation 650). In this instance, determining of whether the screen orientation is to be changed may be similar to operation 420 of FIG. 4, and thus further description thereof is omitted.

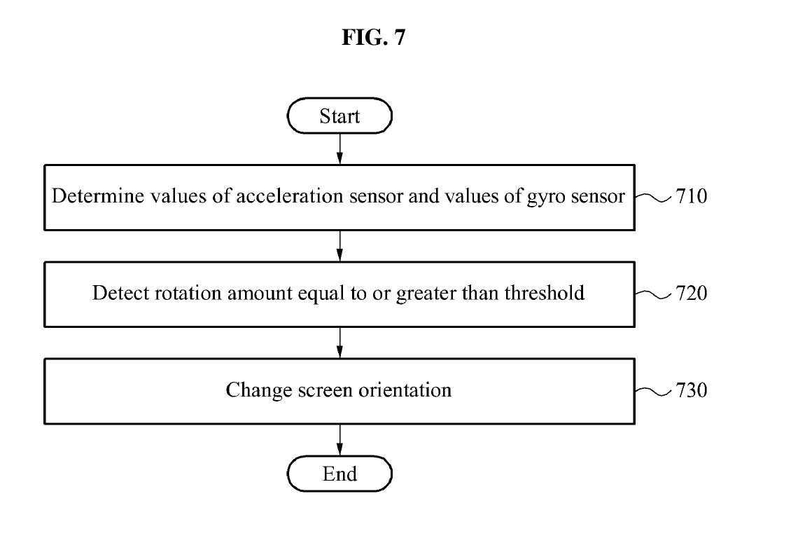

FIG. 7 is a flowchart illustrating a method of changing a screen orientation of a mobile device according to an exemplary embodiment of the present invention.

Referring to FIG. 7, in operation 710, values of an acceleration sensor of the mobile device, and values of a gyro sensor of the mobile device may be determined. In this instance, the values of the acceleration sensor may refer to the X value, the Y value, and the Z value of the acceleration sensor, and the values of the gyro sensor may refer to the X value, the Y value, and the Z value of the gyro sensor described above.

In operation 720, a rotation amount of the mobile device that is equal to or greater than a threshold may be detected. In this instance, the rotation amount of the mobile device may be obtained by converting a degree of rotation of the mobile device into a numerical value, and specifically, may correspond to an amount of a change in the X value and the Y value of the acceleration sensor, and an amount of a change in the X value, the Y value, and the Z value of the gyro sensor.

In the method of FIG. 2A, the screen orientation may be changed based on the Z value of the acceleration sensor. However, the screen orientation may be changed based on another method. Specifically, in the method of FIG. 7, a threshold corresponding to the rotation amount of the mobile device may be set, instead of the threshold corresponding to the Z value of the acceleration sensor. When the rotation amount equal to or greater than the threshold is detected, the method of FIG. 7 may be performed, using the amount of the change in the X value and the Y value of the acceleration sensor, the rate of the change of the acceleration sensor, the amount of the change in the X value, the Y value, and the Z value of the gyro sensor, and the standard deviation of the gyro sensor.

In operation 730, the screen orientation may be changed, based on an amount of a change in the values of the acceleration sensor, and an amount of a change in the values of the gyro sensor. Specifically, an amount of a change in the X value and the Y value of the acceleration sensor, and an amount of a change in the X value, the Y value, and the Z value of the gyro sensor may be extracted. The amount of the change in the X value and the Y value of the acceleration sensor may correspond to the rotation amount of the mobile device. Further, a rate of a change in the X value and the Y value of the acceleration sensor may be calculated, and a standard deviation of the X value, the Y value, and the Z value of the gyro sensor may be calculated.

Whether to change the screen orientation may be determined based on the rate of the change of the acceleration sensor and the standard deviation of the gyro sensor. Specifically, the rate of the change of the acceleration sensor may be compared with a third threshold. When the rate of the change of the acceleration sensor is equal to or greater than the third threshold, it may be determined whether the screen orientation is to be changed based on the amount of the change in the X value and the Y value of the acceleration sensor. When the rate of the change of the acceleration sensor is less than the third threshold, it may be determined whether the screen orientation is to be changed based on the standard deviation of the X value, the Y value, and the Z value of the gyro sensor. In this instance, when the rate of the change of the acceleration sensor is less than the third threshold and the standard deviation of the gyro sensor is less than a fourth threshold that is set in advance, it may be determined whether the screen orientation is to be changed based on the amount of the change in the X value and the Y value of the acceleration sensor. When the rate of the change of the acceleration sensor is less than the third threshold and the standard deviation of the gyro sensor is equal to or greater than the fourth threshold, the screen orientation may remain unchanged.

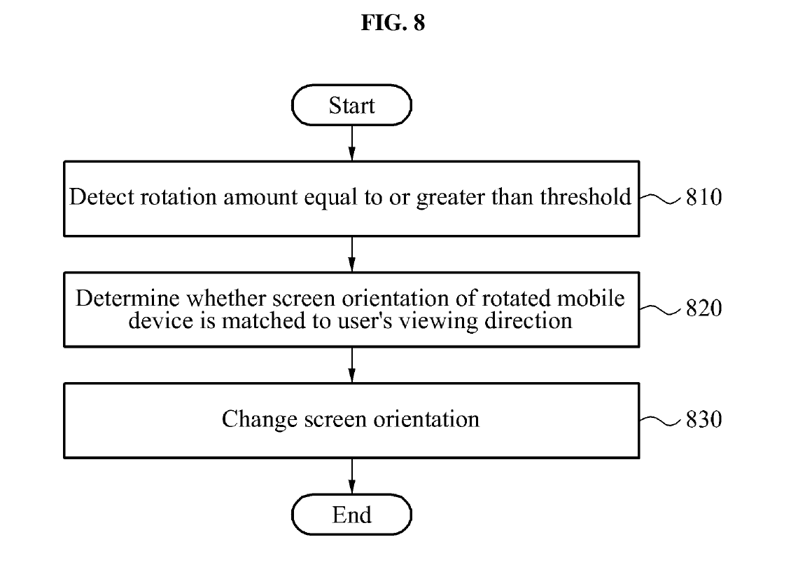

FIG. 8 is a flowchart illustrating a method of changing a screen orientation of a mobile device according to an exemplary embodiment of the present invention.

Referring to FIG. 8, in operation 810, a rotation amount of the mobile device that is equal to or greater than a threshold may be detected. In this instance, the rotation amount of the mobile device may be obtained by converting a degree of rotation of the mobile device into a numerical value, and specifically, may correspond to an amount of a change in an X value and a Y value of an acceleration sensor, and an amount of a change in an X value, a Y value, and a Z value of a gyro sensor. Further, a threshold corresponding to the rotation amount may be set in advance, and it may be determined whether the rotation amount is equal to or greater than the threshold based on the set threshold.

In operation 820, it may be determined whether the screen orientation of the rotated mobile device is matched to a user's viewing direction based on values of an acceleration sensor of the mobile device.

In an example, when the mobile device is rotated and the Z value of the acceleration sensor is equal to or greater than a threshold, the mobile device may be used in a backward tilt mode in which a screen of the mobile device faces upward, and accordingly the screen may be rotated so that the user's viewing direction may not be matched to the screen orientation of the mobile device. In this instance, the user's viewing direction that is not matched to the screen orientation may indicate that the user may view at a portion other than the screen of the mobile device that the user was viewing as a result of rotation of the mobile device without a change in the user's viewing direction.

In another example, when the mobile device is rotated and the Z value of the acceleration sensor is less than the threshold, the mobile device may be used nearly perpendicularly to the ground (in the backward tilt mode or forward tilt mode), or used in the forward tilt mode in which the screen of the mobile device faces downward. Accordingly, the mobile device may be rotated while the user's viewing direction is continuously matched to the screen orientation of the mobile device, or while the user's viewing direction is not matched to the screen orientation. In this instance, the user's viewing direction matched to the screen orientation may indicate that the user may continue to view the screen of the mobile device without changing relative orientation between the screen and the user's eyes, even when the mobile device is rotated and the user's viewing direction is changed.

In operation 830, the screen orientation may be changed, based on the result of operation 820. Specifically, if it is determined that the screen orientation is not matched to the user's viewing direction, the screen orientation may be changed based on an amount of a change in the values of the acceleration sensor. If it is determined that the screen orientation is matched to the user's viewing direction, the screen orientation may be changed based on an amount of a change in the values of the acceleration sensor and based on an amount of a change in the values of the gyro sensor, since a state of a user with respect to the screen orientation may need to be accurately determined.

In this instance, the method of FIG. 8 is similar to the description of FIG. 4, FIG. 5 or FIG. 6, and thus further description thereof is omitted.

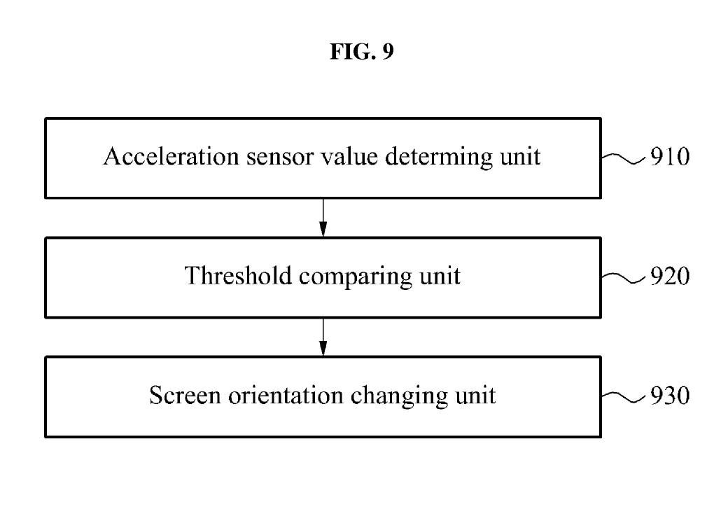

FIG. 9 is a block diagram illustrating a screen orientation change processing unit of a mobile device according to an exemplary embodiment of the present invention.

The screen orientation change processing unit may include an acceleration sensor value determining unit 910, a threshold comparing unit 920, and a screen orientation changing unit 903. Further, a mobile device may include one or more processors, one or more memories, a touch screen display, one or more sensors, and the like. One or more modules or units may be stored on one or more memories and/or may include hardware to implement the operations described above. Referring to FIG. 9, the acceleration sensor value determining unit 910 may determine values of an acceleration sensor of the mobile device. In this instance, the values of the acceleration sensor may be a Z value of the acceleration sensor corresponding to a slope of a screen surface of the mobile device.

The threshold comparing unit 920 may compare the Z value of the acceleration sensor with a threshold. In this instance, the threshold may be set as a reference value of the Z value of the acceleration sensor to determine whether a screen orientation of the mobile device is to be changed.

The screen orientation changing unit 930 may change the screen orientation, based on a result of comparing the Z value of the acceleration sensor with the threshold.

The description of FIG. 1 through FIG. 8 may be applied to the screen orientation change processing unit of FIG. 9, and accordingly further description of the screen orientation change processing unit is omitted.

The method of changing the screen orientation of the mobile device according to the exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and amount of change can be made in the present invention without departing from the spirit or scope of the invention. Thus, it is intended that the present invention cover the modifications and amount of changes of this invention provided they come within the scope of the appended claims and their equivalents.

What is claimed is:

1. A method for changing a screen orientation of a mobile device, the method comprising:
recognizing a motion of the mobile device;
determining whether to change the screen orientation of the mobile device based on a first motion sensor of the mobile device;
determining whether a viewing direction of a user of the mobile device is matched to the screen orientation of the mobile device based on at least one of the first motion sensor and a second motion sensor; and
maintaining the screen orientation of the mobile device in response to a determination that the viewing direction of the user of the mobile device is matched to the screen orientation of the mobile device.

2. The method of claim 1, wherein the first motion sensor is an acceleration sensor, and the second motion sensor is a gyro sensor.

3. The method of claim 1, further comprising:
determining an orientation of a first axis of the mobile device according to a first axis value of the first motion sensor, the first axis of the mobile device being perpendicular to a surface of a display screen of the mobile device.

4. The method of claim 3, wherein, in response to a determination that the orientation of the first axis of the mobile device is in a first range, changing the screen orientation of the mobile device according to a second axis value of the first motion sensor with respect to a second axis of the mobile device.

5. The method of claim 4, wherein the determining of whether the viewing direction of the user of the mobile device is matched to the screen orientation of the mobile device comprises:
in response to a determination that the orientation of the first axis of the mobile device is in a second range, determining whether the viewing direction of the user of the mobile device is matched to the screen orientation of the mobile device based on the first motion sensor and the second motion sensor.

6. The method of claim 5, wherein the first range corresponds to a range from a threshold value to a positive maximum value, and
the second range corresponds to a range from a negative maximum value to the threshold value.

7. The method of claim 5, wherein the second range corresponds to a range from a first negative value to a first positive value, and
the first range includes a range from a negative maximum value to the first negative value and a range from the first positive value to a positive maximum value.

8. A method for changing a screen orientation of a mobile device, the method comprising:
recognizing a motion of the mobile device based on a first motion sensor;
determining an orientation of a first axis of the mobile device according to a first axis value of the first motion sensor, the first axis of the mobile device being perpendicular to a surface of a display screen of the mobile device;
in response to a determination that the orientation of the first axis of the mobile device is in a first range, determining whether to change the screen orientation of the mobile device based on the first motion sensor; and
in response to a determination that the orientation of the first axis of the mobile device is in a second range, determining whether to change the screen orientation of the mobile device based on a second motion sensor or based on a user input.

9. The method of claim 8, wherein the first motion sensor is an acceleration sensor, and the second motion sensor is a gyro sensor.

10. The method of claim 8, wherein the determining of whether to change the screen orientation of the mobile device based on the first motion sensor comprises:
determining whether to change the screen orientation of the mobile device based on at least one of a second axis value of the first motion sensor with respect to a second axis of the mobile device and a third axis value of the first motion sensor with respect to a third axis of the mobile device, the second axis and the third axis being perpendicular to the first axis.

11. The method of claim 10, wherein the first axis, the second axis, and the third axis are the Z axis, the X axis, and the Y axis of a coordinate system, respectively, and
the second axis corresponds to a horizontal direction of the display screen of the mobile device, and the third axis corresponds to a vertical direction of the display screen of the mobile device.

12. The method of claim 8, wherein the determining of whether to change the screen orientation of the mobile device based on the second motion sensor comprises:
determining to maintain the screen orientation of the mobile device if a standard deviation value of the second motion sensor is greater than or equal to a threshold value of the standard deviation value.

13. The method of claim 8, wherein the determining of whether to change the screen orientation of the mobile device based on the second motion sensor comprises:
determining to change the screen orientation of the mobile device according to a value of the first motion sensor if a standard deviation value of the second motion sensor is less than a threshold value of the standard deviation value.

14. The method of claim 8, wherein the first range corresponds to a range from a threshold value to a positive maximum value, and
the second range corresponds to a range from a negative maximum value to the threshold value.

15. The method of claim 8, wherein the second range corresponds to a range from a first negative value to a first positive value, and
the first range includes a range from a negative maximum value to the first negative value and a range from the first positive value to a positive maximum value.

16. A mobile device to change a screen orientation of the mobile device, the mobile device comprising:
a first motion sensor to recognize a motion of the mobile device; and
a determining unit configured to determine an orientation of a first axis of the mobile device according to a first axis value of the first motion sensor, the first axis being perpendicular to a surface of a display screen of the mobile device,
wherein, in response to a determination that the orientation of the first axis of the mobile device is in a first range, the determining unit determines whether to change the screen orientation of the mobile device based on the first motion sensor; and
in response to a determination that the orientation of the first axis of the mobile device is in a second range, the determining unit determines whether to change the screen orientation of the mobile device based on a second motion sensor or based on a user input.

17. The mobile device of claim 16, wherein the determining of whether to change the screen orientation of the mobile device based on the first motion sensor comprises:
determining whether to change the screen orientation of the mobile device based on at least one of a second axis value of the first motion sensor with respect to a second axis of the mobile device and a third axis value of the first motion sensor with respect to a third axis of the mobile device, the second axis and the third axis being perpendicular to the first axis.

18. The mobile device of claim 16, wherein the determining whether to change the screen orientation of the mobile device based on the second motion sensor comprises:
determining to maintain the screen orientation of the mobile device if a standard deviation value of the second motion sensor is greater than or equal to a threshold value of the standard deviation value.

19. The mobile device of claim 16, wherein the determining whether to change the screen orientation of the mobile device based on the second motion sensor comprises:
determining to change the screen orientation of the mobile device according to a value of the first motion sensor if a standard deviation value of the second motion sensor is less than a threshold value of the standard deviation value.

20. The mobile device of claim 16, wherein the first range corresponds to a range from a threshold value to a positive maximum value, and
the second range corresponds to a range from a negative maximum value to the threshold value.
